(19) United States
(12) Patent Application Publication
(10) Pub. No.: US 2003/0065571 A1
(43) Pub. Date: Apr. 3, 2003

(54) SYSTEM, METHOD, AND PROGRAM FOR DETERMINING THE JURISDICTION OF A PRODUCT DELIVERY LOCATION BY USING THE IP ADDRESS OF THE CLIENT WHILE SELLING ITEMS VIA ELECTRONIC COMMERCE OVER THE INTERNET

(76) Inventor: RABINDRANATH DUTTA, AUSTIN, TX (US)

Correspondence Address: MARILYN SMITH DAWKINS, INTERNATIONAL BUSINESS MACHINES CORP, INTELLECTUAL PROPERTY LAW DEPT, 11400 BURNETT ROAD INTERNAL ZIP 4054, AUSTIN, TX, 78758

(21) Appl. No.: 09/417,827

(22) Filed: Oct. 14, 1999

(51) Int. Cl. G06F 17/60

(52) U.S. Cl. 705/26

(57) ABSTRACT

The system, method, and program of the preferred embodiments of the invention address the problem of identifying the jurisdiction of a client that is accessing an e-commerce retailer's Web site in order to know which proper jurisdictional laws to apply to the commercial transaction over the network. Upon receiving a connection request from a client/buyer, the server/retailer determines the IP address of the client from the connection request. The e-commerce server utilizes the IP address of the client as a key into an IP address to physical location/jurisdiction database to determine the physical location and jurisdiction which encompasses the location of the physical network address of the client. The e-commerce server then applies the laws of the corresponding jurisdiction to further negotiate and/or close the sale transaction.

### CROSS REFERENCE TO RELATED APPLICATIONS

A SYSTEM, METHOD, AND PROGRAM FOR ENABLING AN E-COMMERCE DATABASE SERVER TO PROVIDE JURISDICTIONAL INFORMATION TO FACILITATE E-COMMERCE SALES BY A WEB SERVER, (Internal Docket Number AT9-99-573), filed even date herewith, and commonly assigned, is hereby incorporated by reference. A SYSTEM, METHOD, AND PROGRAM FOR DETERMINING THE JURISDICTION OF A PRODUCT DELIVERY LOCATION WHILE SELLING ITEMS VIA ELECTRONIC COMMERCE OVER THE INTERNET, (Internal Docket Number AT9-99-718), filed even date herewith, and commonly assigned, is hereby incorporated by reference.

### BACKGROUND OF THE INVENTION

1. Field of the Invention

This invention relates to electronic commerce (e-commerce) over the Internet, and more specifically to a system, method and program for enabling an e-commerce retailer to determine the geographic location of a requesting buyer anywhere throughout the network environment.

2. Description of the Related Art

The Internet, initially referred to as a collection of “interconnected networks”, is a set of computer networks, possibly dissimilar, joined together by means of gateways that handle data transfer and the conversion of messages from the sending network to the protocols used by the receiving network. When capitalized, the term “Internet” refers to the collection of networks and gateways that use the TCP/IP suite or protocols. Currently, the most commonly employed method of transferring data over the Internet is to employ the World Wide Web environment, referred to herein as “the Web”. Other Internet resources exist for transferring information, such as File Transfer Protocol (FTP) and Gopher, but have not achieved the popularity of the Web. In the Web environment, servers and clients effect data transfer using the Hypertext Transfer Protocol (HTTP), a known protocol for handling the transfer of various data files (e.g., text, still graphic images, audio, motion video, etc.). E-commerce refers to the acts of conducting commercial transactions electronically, such as over the Internet between servers and clients. Because of the ubiquitous nature of the Internet, special problems may arise in connection with commercial transactions over the Internet. For example, the furor in 1999 over Amazon.com selling “Mein Kampf” and other banned books in Germany in violation of German laws has highlighted a problem for e-commerce transactions. Amazon.com and several other booksellers have faced legal problems when they appeared to have violated German laws by shipping banned books to Germany.

This problem does not exist for a physical retailer where the buyer typically comes to the store to complete the transaction because the buyer is physically present within the same jurisdiction as the retailer. The retailer knows the physical location of the buyer and the retailer knows the applicable local laws because both the retailer and the customer are conducting the transaction within the same jurisdiction.

If Amazon.com, the premier distributor of electronic merchandise, could not easily identify the jurisdiction of the buyer and properly apply the applicable laws to a sale to a client within a different jurisdiction, other smaller e-commerce retailers will have even more difficulty in handling these aspects of e-commerce transactions. In addition, the large number of retailers on the Internet magnifies the problem even more.

### SUMMARY OF THE INVENTION

In e-commerce today, there are many situations where the location of the buyer's jurisdiction should be obtained before it is advisable for an e-commerce retailer to commit to a sale over the Internet. It is important that an e-commerce retailer know the buyer's jurisdiction because it is the laws of the buyer's jurisdiction that the retailer may have to apply to various aspects of the commercial transaction with the e-commerce buyer. Some of these laws may include sales taxes, value added taxes (VAT), sale restrictions, other tax laws as they pertain to e-commerce sales, and, in some circumstances, information on customs and duties. Various countries, and states within countries, have different laws as to what products can and can not be sold within the territory of a given country or state. For example, some states within the United States ban the sale of alcohol to anyone via mail or to those under a certain age; and some countries ban the sale of certain categories of books.

The problem identified above is actually twofold. The first aspect of the problem is determining the location, i.e., jurisdiction, of the e-commerce buyer. Once the jurisdiction of the buyer is determined, the second aspect of the problem becomes one of having ready access to the applicable laws of a given jurisdiction, from the number of jurisdictions which the network spans, for a given e-commerce buyer, that govern the transaction.

A related application, (Internal Docket Number AT9-99-573) discloses a system, method, and program for enabling a database server, controlled by a reference authority, within an e-commerce network, to collect and store jurisdictional information from different jurisdictions (e.g., countries, states, and cities), and to transmit the jurisdictional information to Web servers used by e-commerce retailers in transactions with clients for the sale of products over the Internet. The jurisdictional information includes tax types (local, national, value added, customs, sales, etc.) and tax rates and other jurisdiction-specific information. The jurisdictional database server facilitates e-commerce sales via the Web servers by automatically providing the jurisdictional information of the buyer to the e-commerce Web server.

However, before the appropriate jurisdictional laws of the buyer can be applied to an e-commerce transaction, the jurisdiction of the buyer has to be first determined. Because of the widespread nature of the Internet, and the mobility of clients, the physical location of the buyer is not necessarily readily made known to the e-commerce retailer.

The solution is more complicated than merely asking the buyer where the buyer is located physically. First, the buyer's reply may not be trustworthy. Even if a buyer's answer to a query of the buyer's location could be trusted, other problems with querying the buyer arise. If the buyer is queried as to the buyer's jurisdiction at the end of an e-commerce transaction, then unnecessary steps of the transaction may have taken place only to find out that the transaction must be changed or terminated due to the laws governing the transaction for the given jurisdiction. The advantage of determining the jurisdiction of a buyer at the beginning of the transaction enables the buyer to be informed of all aspects of the transaction including restrictions and costs dependent upon the buyer's specific jurisdiction. However, querying the buyer at the beginning of a transaction in order to determine initially any parameters or restrictions that may govern the transaction for a given jurisdiction becomes a nuisance to the buyer, especially if a buyer is checking out many different possible transactions to determine which one is of interest enough to commit to. Such a query from each different Web server as a buyer “shops” around the Internet would be a data entry nuisance for the buyer. People like to shop around the Internet, but if it required for a buyer to input several lines of data including his/her name, address, city, state, country, etc., people may view this as too much of a hassle that outweighs the speed and convenience of looking for the best buys on the Internet. Therefore, a more streamlined user interface and friendly approach to determining a location, i.e., jurisdiction, of a buyer is needed.

The system, method and program of the preferred embodiments of the invention determine the jurisdiction of buyers in e-commerce systems for the purpose of Internet sales and compliance of laws in the jurisdiction. The jurisdiction information from the determined jurisdiction is used to collect and determine applicable taxes and other restrictions relating to the sale to the given buyer.

In one preferred embodiment, as disclosed in related application (Internal Docket Number AT9-99-718), the location of the e-commerce buyer is determined from data stored within a smartcard of the buyer. The smartcard data is received into the client machine of the buyer and transmitted to the seller's server. The smartcard data includes static jurisdiction information such as date of birth, citizenship, and other information such as driver's license information from an issuing authority; dynamic jurisdictional information such as address of residency; and/or geographical positional data that indicates the current location of the cardholder from a multi-satellite based location determining system.

The preferred embodiment, as disclosed herein, has an e-commerce server that is communicatively connected to a plurality of clients dispersed across multiple geographical jurisdictions. The e-commerce server is connected to a database of IP addresses that are mapped to physical locations. As such, the Internet address of each client computer is mapped to the physical location of the computer. A preferred embodiment utilizes the fact that IP addresses are allocated uniquely and are registered on a geographical basis according to allocation guidelines. Therefore, it is possible to locate, within a reasonable degree of accuracy, the jurisdiction of a buyer by the IP address of the client machine being used by the buyer in the e-commerce transaction.

As such, the system, method, and program of the invention determines dynamically, and automatically, a physical location of a client participating in the commercial transaction over the network with the server. Instead of querying the buyer for the buyer's physical location, the server dynamically determines the location by using the network address of the client from the client's connection request. The server then automatically retrieves the physical location corresponding to the network address from a database. The determined physical location is then used to apply applicable laws of a jurisdiction encompassing the physical location to the commercial transaction between the server and the client.

Most computers today have fixed IP addresses. Using a database of IP addresses to determine location of a client is currently sufficient for a large percentage of e-commerce transactions. Mobile IP proposals may change this in the future. For the near future, however, determining the geographical location of an e-commerce buyer based upon the buyer's IP address has present day advantages.

### BRIEF DESCRIPTION OF THE DRAWINGS

For a more complete understanding of the present invention and the advantages thereof, reference should be made to the following Detailed Description taken in connection with the accompanying drawings in which:

FIG. 1 illustrates the structure of the system with an e-commerce server in connection with an IP address to physical location/jurisdiction database;

FIG. 2 provides a flowchart illustrating the control flow in the system;

FIG. 3 is a structure of the IP address to physical location/jurisdiction database;

FIG. 4 is a flowchart for entering information into the database;

FIG. 5 shows a page from the allocation of the Internet Protocol Address Space; and

FIG. 6 illustrates a block diagram of a computer system that may be used as a server and/or a client in the network system.

### DETAILED DESCRIPTION OF THE PREFERRED EMBODIMENTS

In the following description, reference is made to the accompanying drawings which form a part hereof, and which illustrate several embodiments of the present invention. It is understood that other embodiments may be utilized and structural and operational changes may be made without departing from the scope of the present invention.

The system, method, and program of the preferred embodiment of the invention addresses the problem of identifying the jurisdiction of a client that is accessing the e-commerce retailer's web site in order to know which proper jurisdictional laws to apply to the transaction.

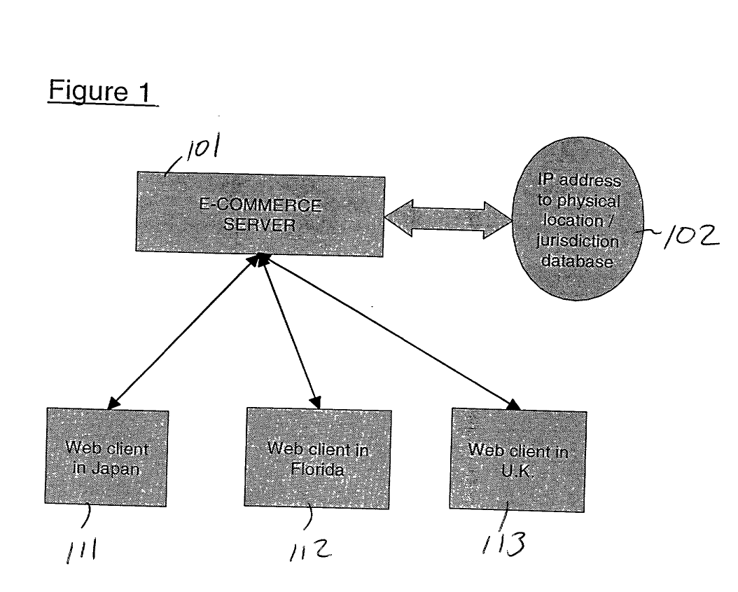

FIG. 1 shows the Internet-based system that determines the location of the buyer in order to apply, or provide warnings of, jurisdictional laws that are applicable to the e-commerce transaction. An e-commerce server 101 utilizes the IP address of a client 111, 112, or 113, as a key into an IP address to physical location/jurisdiction database 102.

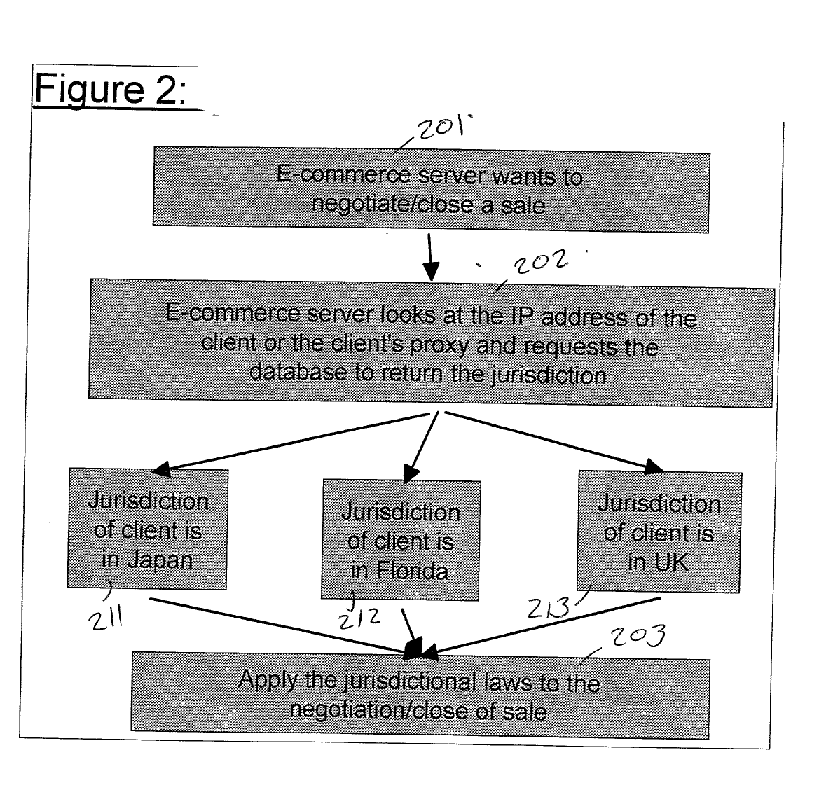

FIG. 2 shows the process flow of a preferred embodiment of the invention. The e-commerce server desires to negotiate and/or close an e-commerce sale, 201. The e-commerce server examines the IP address of the client or the client's proxy; and requests the “IP address to physical location/jurisdiction” database to look up and return the jurisdiction corresponding to the IP address of the client, 202. The e-commerce server then applies the laws of the corresponding jurisdiction to further negotiate and/or close the sale transaction, 203. This is further illustrated by blocks 211, 212, 213 showing different possible jurisdictions of different clients. Depending upon the physical location, the laws of the corresponding jurisdiction are applied. In a preferred embodiment, as disclosed in copending application Ser. No. ______ (Internal Docket Number AT9-99-573), an e-commerce web server, (e.g., 101, FIG. 1), after accessing the database, (e.g., 102, FIG. 1), for the jurisdiction, would then access a jurisdictional web server that has, or has access to, the laws of each jurisdiction.

The two parts to step 202—examining the IP address of the client by the server, and determining the jurisdiction from the IP address—are further discussed below.

Determining the IP address of a client by a server is further described. When a Web client connects to a Web server over the HTTP protocol, it must send its IP address if it is to receive data from the server. The HTTP protocol is written over the TCP/IP protocol. In the TCP/IP protocol, each Internet host has an unique IP address. The client sets up a TCP/IP connection to the server. In the process of setting up this connection, the client IP address is made known to the server. This information is passed to the system, method, and program of this invention. For example if a client having an IP address of 9.53.125.176 were to contact to Web server www.evpost.co.nz for data, it would set up a TCP/IP connection with 202.36.60.9. The Web server www.evpost.co.nz with IP address 202.36.60.9 would know that IP address 9.53.125.176 is contacting it. Hence, after processing, it would return data to IP address 9.52.125.176. As such, the Web server knows the IP address of the client.

There are situations where the client connects via a proxy server such as aol.com. In such cases, the Web server may not directly know the IP address of the Web client but knows the IP address of the proxy server. In the overwhelming majority of situations, Web clients connect to Web servers via proxy servers located within their own jurisdiction. It is rare for a person in United Kingdom to dial-up an America Online service provider in USA and connect to the Internet. Hence in the vast majority of situations, using the jurisdiction of the proxy instead of the actual client would cause no difference to the result. Hence, for the remainder of the application, reference to the network address or IP address of the client shall refer to the address of the client or the proxy of the client, i.e., a computer acting on behalf of a client.

Determining the physical location of an IP address is further discussed. As evidence by the above, an IP address is a physical wiring which is uniquely identified by a sequence of numbers. The numbers are unique to each computer. The Internet Authority, by an international convention, has allocated different groups or sequences of numbers for different regions of the world. Although it may not be possible to know, based upon the allocation, the specific building, floor, or room where a specific IP address is physically wired, the granularity of allocated IP addresses can reveal different geographical regions.

The following excerpt from RFC 2050 Internet Registry IP Allocation Guidelines, November 1996, illustrates that IP addresses are given uniquely, and are registered on a geographical basis. Hence it is possible to locate to a reasonable degree of accuracy the location of a particular IP address by matching the IP address with a database that contains IP addresses and their physical location/jurisdiction.

RFC 2050

The Internet Registry hierarchy consists of the following levels of hierarchy as seen from the top down: IANA, Regional IRs, Local IRs.

IANA

The Internet Assigned Numbers Authority has authority over all number spaces used in the Internet. This includes Internet Address Space. IANA allocates parts of the Internet address space to regional IRs according to its established needs.

Regional IRs

Regional IRs operate in large geopolitical regions such as continents. Currently there are three regional IRs established; InterNIC serving North America, RIPE NCC serving Europe, and AP-NIC serving the Asian Pacific region. Since this does not cover all areas, regional IRs also serve areas around its core service areas. It is expected that the number of regional IRs will remain relatively small. Service areas will be of continental dimensions.

Regional IRs are established under the authority of the IANA. This requires consensus within the Internet community of the region. A consensus of Internet Service Providers in that region may be necessary to fulfill that role.

The specific duties of the regional IRs include coordination and representation of all local IRs in its respective regions.

Local IRs

Local IRs are established under the authority of the regional IR and IANA. These local registries have the same role and responsibility as the regional registries within its designated geographical areas. These areas are usually of national dimensions.

As shown above, specific IP addresses are allocated to specific physical regions. The physical region corresponding to an IP address can be determined in many ways. One of the ways is to perform a reverse lookup of domain name corresponding to the IP address. For example, IP address 165.69.1.120 when looked up in a reverse lookup domain name server may translate to www.theadvertiser.com.au. The suffix ‘au’ in the domain name in virtually all instances refers to a computer located in the country of Australia. Hence it can be concluded that IP address 165.69.1.120 is from Australia. Some other suffixes that refer to some particular countries are as follows:

.cn for China

.in for India

.uk for United Kingdom

.nz for New Zealand

.jp for Japan

.ca for Canada

It is true that for several countries, computers located outside the country can register domain names with the country suffix. However, in general for the overwhelming majority of situations, a country suffix typically identifies the jurisdiction of the client. Currently there are 191 countries that register domain names. It should be noted that reverse look up on IP addresses can be done by contacting appropriate domain name servers.

The domain name can also be found from an IP address in several other ways which essentially involve performing the same reverse lookup of a domain name server. For example, a typical program is “nslookup” that when given the IP address of a computer as a parameter returns the equivalent domain name.

In many instances the reverse lookup may not appropriately indicate a country. Such a situation is common with domain names ending in .com, net and .org which are not country specific. Such domains are called “global domains”. In the case of global domains, it would be necessary to compile a database from the information provided by registration authorities. Typically, registration authorities like Network Solutions keep the physical address of a registrant in their database. The database of the preferred embodiment can be compiled directly or indirectly by aggregating the information present with various IP address registrars.

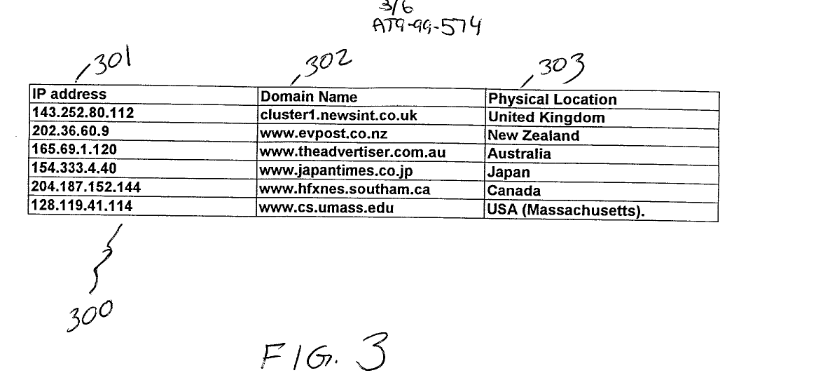

The structure of the database 300 is shown in FIG. 3. As can be seen, the first column 301 contains the IP address. The second column 302 contains the corresponding domain name; and the third column 303 contains the jurisdiction. The database is constructed from the methods outlined earlier including mapping country domains like .uk, .nz etc. and collecting information from domain name registrars.

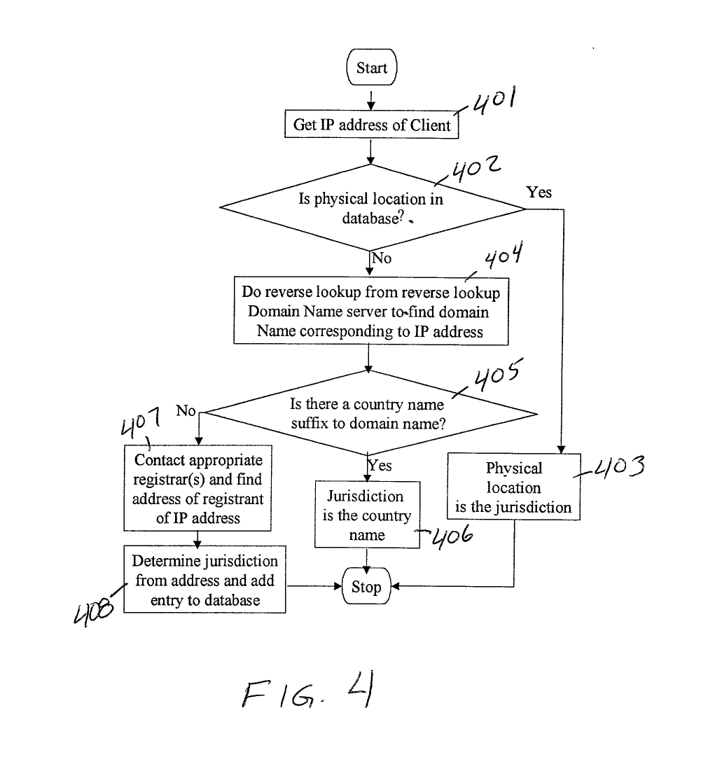

A flowchart of the system of entering information into the database is given in FIG. 4. When the database server encounters a client IP address 401, the IP address may already be present in the database, or it may be absent from the database, 402. If the IP address is present, the physical location field 303 (FIG. 3) can easily be extracted by a database search on the IP address 301 (FIG. 3). This physical location is the jurisdiction 403. If the IP address is not in the database, the domain name is determined as explained earlier (nslookup or reverse lookup of domain name from IP address) 404. It is then determined if the domain name has a country name suffix, 405. If it does, the jurisdiction is the country name, 406. If the domain name does not have a country name suffix, the physical location is determined on the fly by finding the registrant information by consulting the Internet IP registrars over the Internet for the IP address 407. The physical location, i.e., jurisdiction, is determined from the IP address, and the entry is added to the database, 408.

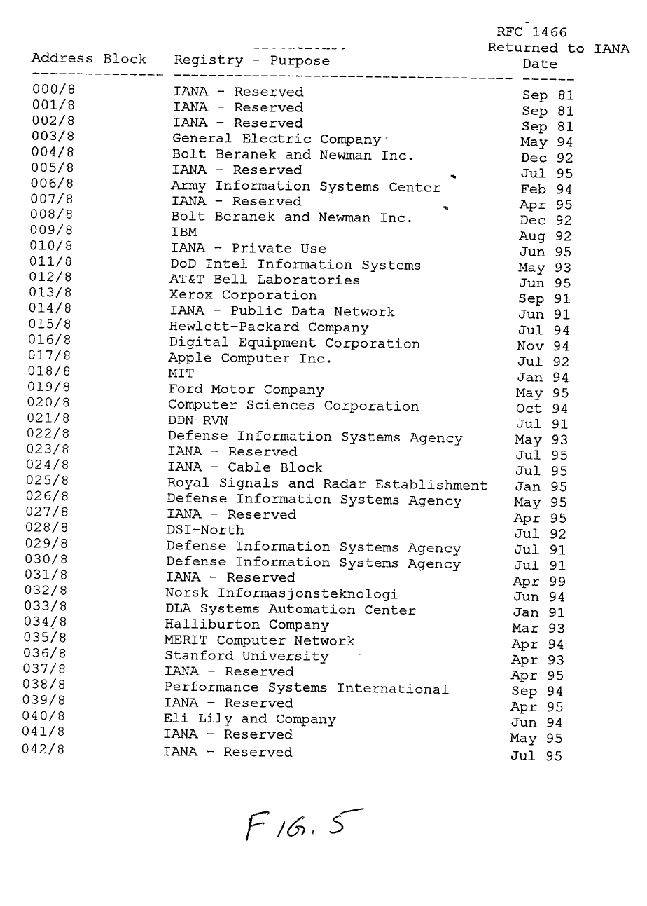

A page from the allocation of Internet Protocol version 4 (IPv4) address space to various registries is shown in FIG. 5. Originally, all of the IPv4 address spaces were managed directly by the IANA. Later, parts of the address space were allocated to various other registries to manage for particular purposes or regional areas of the world. RFC 1466 documents most of these allocations.

Given any IP address, it is possible to refer to the Internet protocol address space and determine the appropriate registry or in some cases the registrant itself. A simple example from FIG. 5, is that IP address 18.62.1.6 which translates to eecs.mit.edu was awarded to MIT from the Address Block information 018/8. Hence, contacting the appropriate registrar is feasible from the IP address itself.

The preferred embodiments may be implemented as a method, system, or article of manufacture using standard programming and/or engineering techniques to produce software, firmware, hardware, or any combination thereof. The term “article of manufacture” (or alternatively, “computer program product”) as used herein is intended to encompass program code, and/or one or more computer programs, and/or data files accessible from one or more computer-readable devices, carriers, or media, such as magnetic storage media, “floppy disk”, CD-ROM, a file server providing access to the programs via a network transmission line, holographic unit, etc., or any other signal bearing media. Of course, those skilled in the art will recognize that many modifications may be made to this configuration without departing from the scope of the present invention.

The foregoing description of the preferred embodiments of the invention has been presented for the purposes of illustration and description. It is not intended to be exhaustive or to limit the invention to the precise form disclosed. Many modification and variations are possible in light of the above teaching. For example, although preferred embodiments of the invention have been described in terms of the Internet, other network environments including but not limited to wide area networks, intranets, and dial up connectivity systems using any network protocol that provides basic data transfer mechanisms may be used. As such, any network environment and network protocol could be used as long as the network address of the buyer (client) is received, preferably automatically, by the seller (server) when the e-commerce buyer contacts the e-commerce seller; and there is some means for correlating the network address to a physical location. It is further noted that RFC's are frequently updated and the RFC's mentioned in the embodiment are for illustrative purposes only.

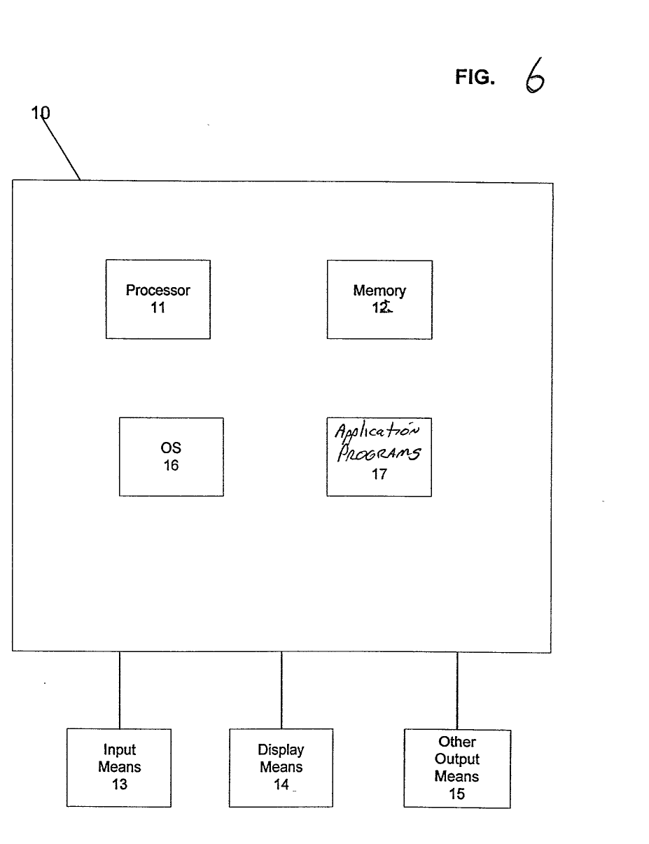

FIG. 6 depicts a block diagram of a typical computer system used as a client or server or both. The computer includes at least one processor 11 and memory 12. The computer may be, but is not limited to, a personal computer, laptop, workstation, mainframe or hand held computer including palmtops, personal digital assistants, smart phones, cellular phones, etc. The computer system includes input means 13 such as keyboard, mouse, track ball, light pen, pen-stylus, voice input system, touch sensitive device, and/or any other input means. Also included are display means 14 and/or any other output device including network communication devices. Memory 12 includes volatile or nonvolatile storage and/or any combination thereof. Volatile memory may be any suitable volatile memory device, e.g., RAM, DRAM, SRAM, etc. Nonvolatile memory may include storage space, e.g., via the use of hard disk drives, tapes, etc., for data, databases, and programs. The programs in memory include an operating system 16 and application programs 17. For the client, one of the application programs would include a browser.

The exemplary embodiment shown in FIG. 6 is provided solely for the purposes of explaining the preferred embodiments of the invention; and those skilled in the art will recognize that numerous variations are possible, both in form and function. For instance, any one or more of the following—the processor and/or memory and/or the input/output devices—could be resident on separate systems such as in a network environment.

It is intended that the scope of the invention be limited not by this detailed description, but rather by the claims appended hereto. The above specification, examples and data provide a complete description of the manufacture and use of the system, method, and article of manufacture, i.e., computer program product, of the invention. Since many embodiments of the invention can be made without departing from the spirit and scope of the invention, the invention resides in the claims hereinafter appended.

Having thus described the invention, what we claim as new and desire to secure by Letters Patent is set forth in the following claims.

1. A method for use in conjunction with a commercial transaction within a network environment, comprising:
determining dynamically, by a server, a physical location of a client participating in the commercial transaction over the network with the server; and
using the determined physical location to apply applicable laws of a jurisdiction encompassing the physical location to the commercial transaction between the server and the client.

2. The method of claim 1 wherein the step of determining comprises receiving, by the server from the client, in association with a connection request from the client to the server, a network address of the client; and retrieving the physical location corresponding to the network address from a database.

3. The method of claim 2 wherein the connection request is an HTTP request and the network address is an IP address.

4. The method of claim 2 wherein the step of determining is carried out in response to an initial contact between the client and the server, and the step of using further comprises applying the applicable laws to the commercial transaction before the client is committed to the transaction.

5. The method of claim 4 wherein the step of applying the applicable laws comprises informing the client of at least one of the following: i) age restrictions to the transaction; ii) applicable taxes; and iii) whether a product involved in the commercial transaction is banned.

6. A method for use in conjunction with a commercial transaction within a network environment, comprising:
setting up a connection, from a client to a server participating in the commercial transaction within the network, wherein the network address of the client is made known to the server as a result of the setting up of the connection; and
receiving, at the client from the server, information about the commercial transaction based upon at least one law of a jurisdiction encompassing a physical location of the network address.

7. The method of claim 6 wherein the step of receiving is received before the client is committed to the transaction.

8. The method of claim 6 wherein the information received comprises at least one of the following: i) age restrictions to the transaction; ii) applicable taxes; and iii) whether a product involved in the commercial transaction is banned.

9. A system, participating with a client in a network environment in a commercial transaction, comprising:
means for dynamically determining a physical location of a client participating in the commercial transaction over the network with the system; and
means for applying, based upon the determined physical location, applicable laws of a jurisdiction encompassing the physical location to the commercial transaction between the system and the client.

10. The system of claim 9 wherein the means for determining comprises means for receiving, by the system from the client, in association with a connection request from the client to the server, a network address of the client; and means for retrieving the physical location corresponding to the network address from a database.

11. The system of claim 10 wherein the means for determining is carried out in response to an initial contact between the client and the system, and the means for applying the applicable laws to the commercial transaction are applied before the client is committed to the transaction.

12. The system of claim 11 wherein the means for applying the applicable laws comprises means for informing the client of at least one of the following: i) age restrictions to the transaction; ii) applicable taxes; and iii) whether a product involved in the commercial transaction is banned.

13. A system, participating with a server in a network environment in a commercial transaction, comprising:
means for setting up a connection, from a client to a server participating in the commercial transaction within the network, wherein the means for setting up the connection comprises means for making known to the server a network address of the client; and
means for receiving, at the client from the server, information about the commercial transaction based upon at least one law of a jurisdiction encompassing a physical location of the network address.

14. The system of claim 13 wherein the means for receiving receives the information before the client is committed to the transaction.

15. The system of claim 14 wherein the information received comprises at least one of the following: i) age restrictions to the transaction; ii) applicable taxes; and iii) whether a product involved in the commercial transaction is banned.

16. A computer program on a computer usable medium for controlling a computer participating in a commercial transaction within a network, comprising:
means for dynamically determining a physical location of a client participating in the commercial transaction over the network with the computer; and
means for applying, based upon the determined physical location, applicable laws of a jurisdiction encompassing the physical location to the commercial transaction between the computer and the client.

17. The computer program of claim 16 wherein the means for determining comprises means for receiving, by the system from the client, in association with a connection request from the client to the server, a network address of the client; and means for retrieving the physical location corresponding to the network address from a database.

18. A computer program on a computer usable medium for controlling a computer participating in a commercial transaction within a network, comprising:
means for setting up a connection, from a client to a server participating in the commercial transaction within the network, wherein the means for setting up the connection comprises means for making known to the server a network address of the client; and
means for receiving, at the client from the server, information about the commercial transaction based upon at least one law of a jurisdiction encompassing a physical location of the network address.
